(19) United States
(12) Patent Application Publication
(10) Pub. No.: US 2017/0347427 A1
(43) Pub. Date: Nov. 30, 2017

(54) LIGHT CONTROL

(71) Applicant: AMBX UK LIMITED, Surrey (GB)

(72) Inventors: Richard Stephen COLE, Surrey (GB); David Anthony EVES, West Sussex (GB)

(21) Appl. No.: 15/527,136

(22) PCT Filed: Nov. 11, 2015
(86) PCT No.: PCT/GB2015/000299

§ 371 Date: May 16, 2017

(30) Foreign Application Priority Data
Nov. 20, 2014 (GB) 1420643.7

(51) Int. Cl. H05B 37/02

(52) U.S. Cl. CPC H05B 37/029

(57) ABSTRACT

A method of controlling a plurality of lights of a lighting installation comprises the steps of receiving a framework defining the plurality of lights of the lighting installation, the framework comprising a video frame, creating a plurality of different coloured versions of the framework, locating each of the different coloured versions of the framework on a timeline of video frames, applying transition effects between the located different coloured versions of the framework on the timeline to create intermediate video frames thereby generating a sequence of video frames, transmitting the sequence of video frames to a lighting controller for the lighting installation, and controlling the plurality of lights of the lighting installation according to the sequence of video frames.

This invention relates to a method of, and system for, controlling a plurality of lights of a lighting installation.

In many different environments, lighting systems are becoming more complicated and sophisticated. For example, in a nightclub or music venue, a large number of different lights will be installed that can provide a large number of different effects and colours to different parts of the environment. Such lighting installations are used in very large venues such as concert stadiums and also in relatively small spaces such as rooms within a private home.

Generally in such a sophisticated lighting installation that uses multiple lights that have multiple different configurations (such as colour and brightness) it is necessary to have some sort of central control of the lights in an efficient and effective hardware or software solution. For example, a lighting board may be provided which is connected to all of the lights in the lighting installation and the lighting board can be used to control all of the lights individually and/or collectively in terms of their brightness and colour etc.

However, in very large installations of lights, the use of a lighting board is impractical given the very large number of lights involved, and so a specific computer hardware is used under the control of a lighting control software package that allows all of the lights to be controlled at different levels of granularity in order to ensure that the skilled controller of the lights is able to set all of the lights as they wish and to change the outputs of the lights over time. However, such a software solution creates problems in that a fairly high level of sophistication is required on the part of the user of the software and the creation and re-use of lighting schemes for the software is a non-trivial task for most except the very sophisticated technology users.

It is therefore an object of the invention to improve upon the known art.

According to a first aspect of the present invention, there is provided a method of controlling a plurality of lights of a lighting installation, the method comprising the steps of receiving a framework defining the plurality of lights of the lighting installation, the framework comprising a video frame, creating a plurality of different coloured versions of the framework, locating each of the different coloured versions of the framework on a timeline of video frames, applying transition effects between the located different coloured versions of the framework on the timeline to create intermediate video frames thereby generating a sequence of video frames, transmitting the sequence of video frames to a lighting controller for the lighting installation, and controlling the plurality of lights of the lighting installation according to the sequence of video frames.

According to a second aspect of the present invention, there is provided a system for controlling a plurality of lights of a lighting installation, the system comprising a processor arranged to receive a framework defining the plurality of lights of the lighting installation, the framework comprising a video frame, create a plurality of different coloured versions of the framework, locate each of the different coloured versions of the framework on a timeline of video frames, apply transition effects between the located different coloured versions of the framework on the timeline to create intermediate video frames thereby generating a sequence of video frames, transmit the sequence of video frames to a lighting controller for the lighting installation, and control the plurality of lights of the lighting installation according to the sequence of video frames.

According to a third aspect of the present invention, there is provided a computer program product on a computer readable medium for controlling a plurality of lights of a lighting installation, the product comprising instructions for receiving a framework defining the plurality of lights of the lighting installation, the framework comprising a video frame, creating a plurality of different coloured versions of the framework, locating each of the different coloured versions of the framework on a timeline of video frames, applying transition effects between the located different coloured versions of the framework on the timeline to create intermediate video frames thereby generating a sequence of video frames, transmitting the sequence of video frames to a lighting controller for the lighting installation, and controlling the plurality of lights of the lighting installation according to the sequence of video frames.

Owing to the invention, it is possible to provide a new kind of light experience authoring and playback delivery method. Standard video editing and authoring tools will allow the creation of an animated sequence of colours to be used in the control of lights in a lighting installation. This sequence can be associated with a pre-existing piece of video material or other media.

There are two main advantages to the new approach. Firstly there is no need for a new representation language for the lighting information. The colour information is provided in a format that is apparent and intuitive to most people and can be extrapolated by video to light algorithms of the lighting system. Secondly the authoring of such information can be done in a domain where there are already well established tools and techniques and plenty of people skilled in the art can easily interpret the representation in terms that are familiar to them. Creation of lighting experiences around media can therefore be part of a standard post production process without learning new production skills or developing/purchasing new software.

Automatic techniques can be used to analyse live video feeds and generate corresponding lighting effects from the content. This can be done by applying a colour detection algorithm on a section of a video source and associating that with an area of the space that is being lit. Light devices in the space have a corresponding association with their location in that space and where a match is found they will reproduce the desired light effect. A video region analysis software tool will look at the colour content of the sequence of video frames and use this to create a lighting pattern for the lights in the lighting installation.

In this way tools can be designed to allow the creation of a certain template or layout of colour regions that have a known association into the space being lit. These can be fixed colours or animated sequences. The video sequence containing the video frames is a lighting representation that can be delivered as a part of the core media and then stripped or left out of the active display area or can be provided in a synchronised yet separate video channel. For example, the video frames for the light control can be provided as an alternative angle in a DVD or in a metadata track such as a digital teletext page.

Extending this idea, patterns and segments of video can be cued into the light map video region to allow the authoring process to trigger certain pre-defined visual effects. These patterns may even be time based video sequences, so for example an animation that will generate a lightning style effect in the selected region. Using such an approach the authoring could also happen in real time or be triggered from software or sensors.

Preferably, the framework, which is a video frame, comprises a two-dimensional grid and the framework defines the relative location of the plurality of lights of the lighting installation. The creator of the lighting effects can be provided with a single two-dimensional grid as the usable framework, which represents the relative locations of the effects produced by the lights that form the lighting installation. The framework can define the three-dimensional location of the plurality of lights of the lighting installation. The grid can comprise a selection of different shapes that effectively mirror the location, size and shape of lighting effects within the lighting installation and a simple visual editing tool can be used to add colour to the framework to create a single instance of the framework and this process can be repeated as desired by the creator, thereby generating multiple different instances of the framework, which are dropped into a timeline of video frames.

Advantageously, the method further comprises receiving an input defining the nature of a transition effect to be applied between two different coloured versions of the framework located on the timeline. Once the different instances of the framework have been located on the timeline, then transition effects will be applied in order to generate intermediate frames, thereby generating a sequence of video frames. The transitions to be used can be selected by the user directly as they use the tool to generate the final video output. This provides the user with control over how the intermediate frames are generated and will provide a final video output that can be used to control the lights in the lighting installation using a video to light tool which will automatically control the output of the lights according to the contents of the framework as embodied in each frame of the video sequence.

Embodiments of the present invention will now be described, by way of example only, with reference to the accompanying drawings, in which:—

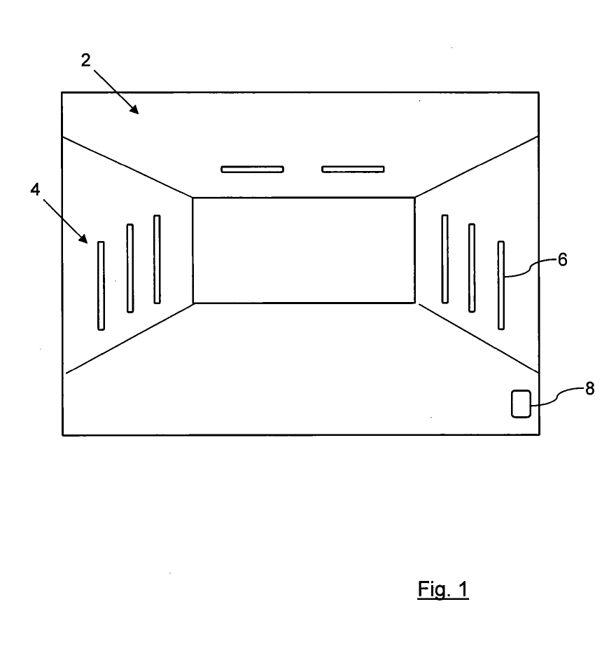

FIG. 1 is a schematic diagram of a lighting installation in a room,

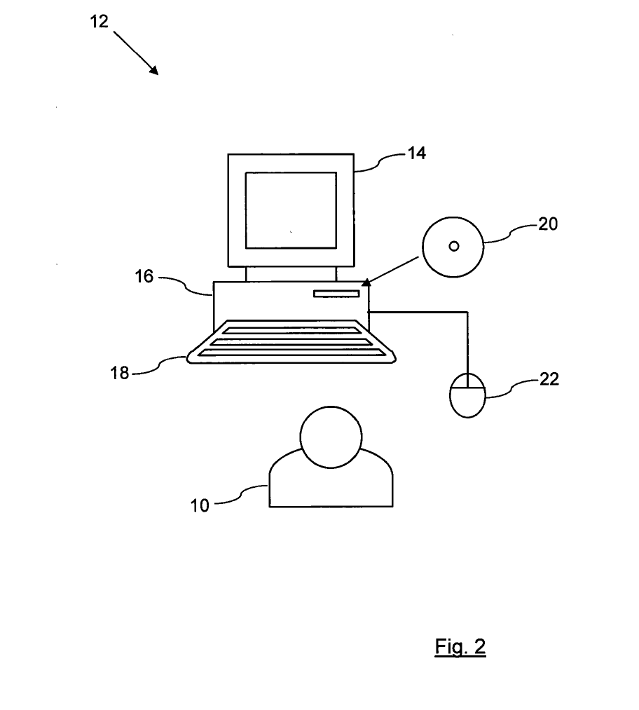

FIG. 2 is a schematic diagram of a computing system,

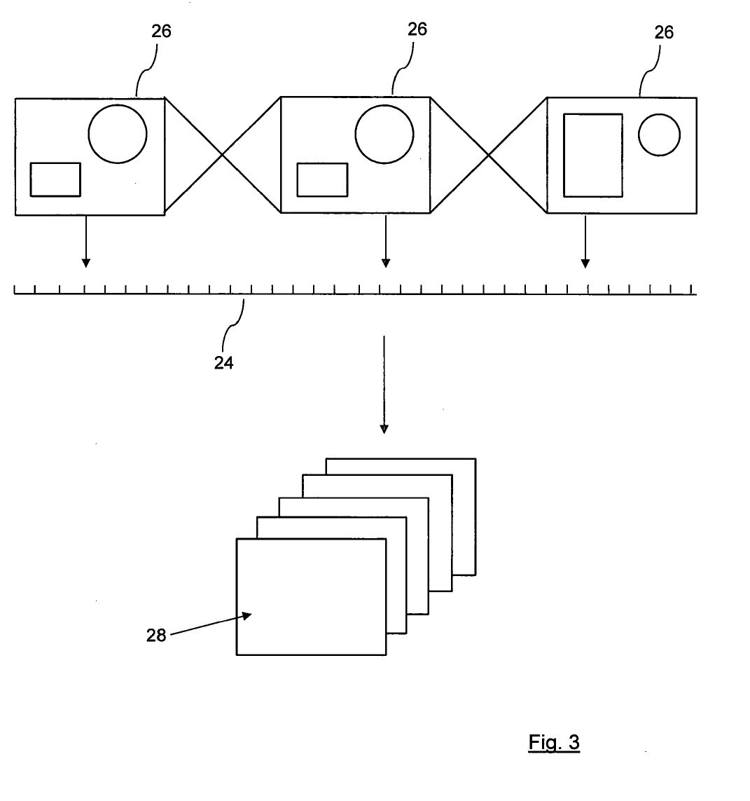

FIG. 3 is a schematic diagram of a timeline of video frames,

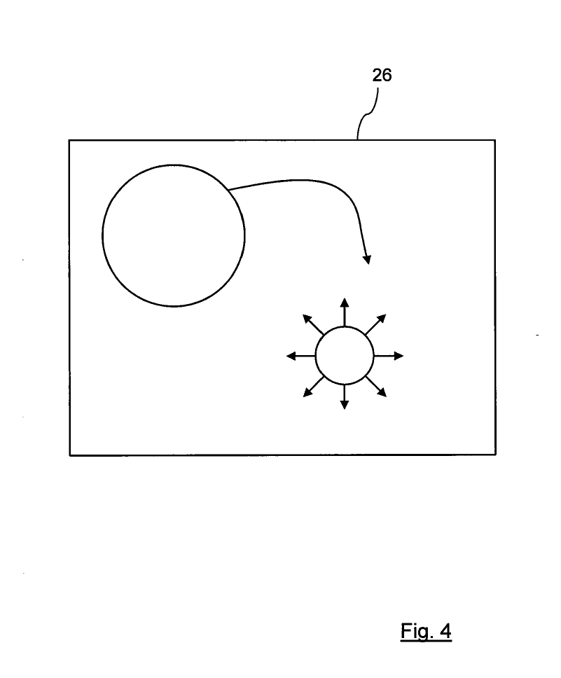

FIG. 4 is a schematic diagram of a video frame,

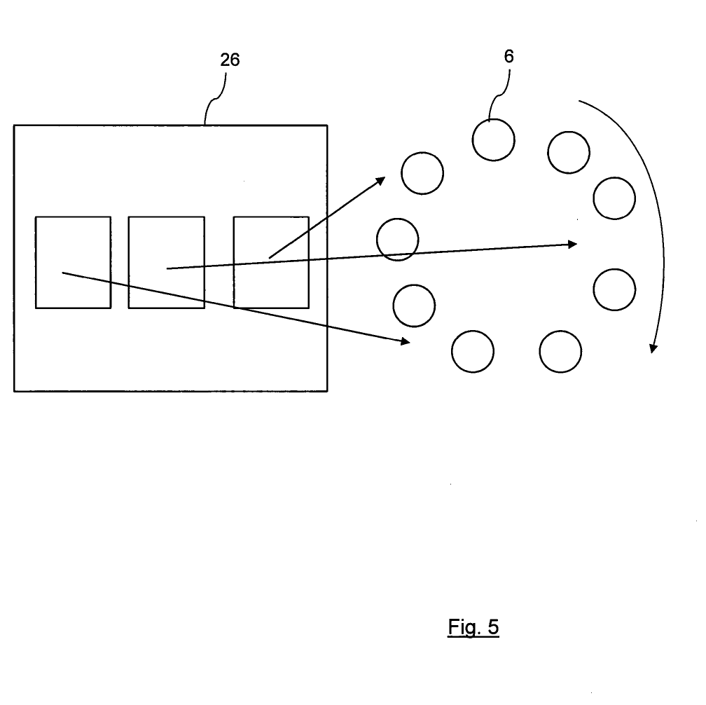

FIG. 5 is a schematic diagram of a video frame and corresponding lights, and

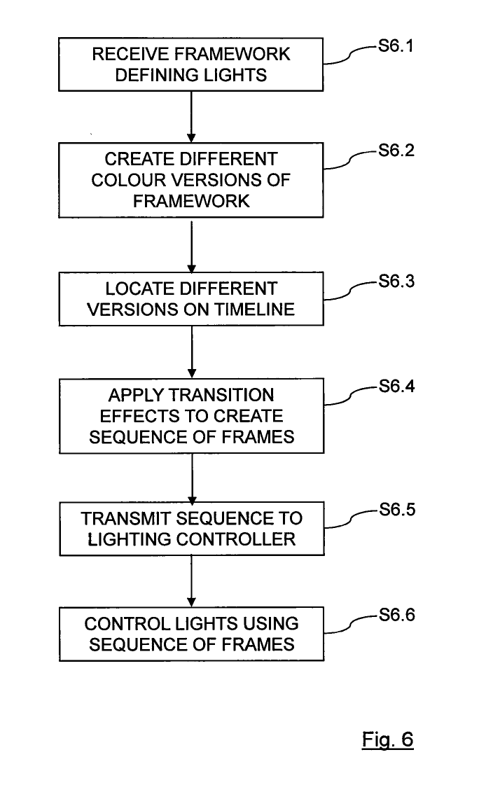

FIG. 6 is a flowchart of a method of controlling lights.

FIG. 1 shows schematically a room 2, which has a sophisticated lighting installation 4 included therein. The light installation 4 comprises a plurality of different lights 6 which can provide a wide variety of different lighting effects such as changes in colour and brightness, all of which can be controlled from a central lighting controller 8. The room 2 could be a function room in a hotel for example, which can be used for live music events and/or parties and so on. The room 2 could also support the output of digital audio/visual content, such as the broadcast of a film onto a suitably located screen within the room 2.

If the room 2 is being used for the broadcast of content such as a film or the live relay of a performance such as a play in a theatre, then the lighting installation 4 can be controlled to provide augmenting effects alongside the broadcast of the content. So a winter scene at night in the content could be augmented with the use of low level blue lighting throughout the room 2, an explosion in the content at the right-hand side of the screen could be augmented with a suitably located flash of bright red and yellow light from lights located to the right of the screen and so on.

If the room 2 is being used for a live event such as a party or celebration, then music may be being provided by a DJ, for example. The control of the lighting installation 4 to match the mood of the music and the atmosphere of the live event is highly desirable and this can be delivered by the lighting installation 4. Different volumes and beat rates of music suit different lighting conditions and colour and movement of light in the room 2 can all be used to augment the live experience of the music being played or simply to entertain the party goers if no music is currently being played.

FIG. 2 shows a lighting author 10 using a desktop computer system 12 to create a video sequence that can be used to control the lighting installation 4. The computer system 12 comprises a display device 14, a processor 16 and a user input device (a conventional keyboard) 18. The processor 16 is connected to the display device 14 and the user input device 18. The processor 16 is running an operating system with which the user 10 can interact via a graphical user interface of the operating system, which is being displayed by the display device 14. A CD-ROM 20 is shown, which can be used to store a copy of a computer program product which is being executed by the processor 16.

An additional user interface device 22 is also shown, which is a conventional mouse 22. The user 10 utilises the keyboard 18 and mouse 22 to interact with the operating system and applications being run by the processor 16. Normal imaging and video creation software can be used to create images and a video sequence to be used to control the lighting installation 4, shown in FIG. 1. In its simplest form, different colours can be used to create an image that will be used to control the lights 6 of the lighting installation 4, via a video to light tool that converts the video frames into specific lighting instructions for the lighting controller 8.

The basic unit that the user 10 will use is a framework (a video frame) that defines the plurality of lights 6 in the lighting installation 4 (the framework is described in more detail below with reference to FIG. 3). In a preferred embodiment, the framework is a two-dimensional grid of simple shapes that represents in a single video frame the physical location of the lights 6 and their associated effects. The user 10 will create different versions of the framework and locate them in a timeline of video frames. Transition effects will then be applied to pairs of frames in order to create intermediate frames between those created by the user 10, thereby creating a sequence of video frames.

FIG. 3 shows a timeline 24 of video frames 26, where the three video frames 26 shown have been created by a user filling in a framework, which is a video frame with a defined structure such as a grid, with colours and then locating them in the timeline 24. Using a standard timeline based video editing tool it is possible to create a sequence of images and transitions between those without any specialist lighting system knowledge, thereby generating a sequence 28 of video frames. Areas of the image are designated to areas of lighting but the video tool will handle smooth effects over time.

The resulting video 28 is produced in a standard form suitable to be broadcast or distributed and played back on standard equipment as appropriate to control a space. The sequence 28 of video frames 26 is transmitted to the lighting controller 8 of the lighting installation 4 which is able to control the lights 6 of the lighting installation using video to light processing. The video 28 dictates the timing of the lighting control, in that the timing of changes are captured in the actual playback speed of the video 28. The video can be paused or played at different speeds and the lighting effects will be controlled accordingly.

The same video can be used to control multiple spaces and the mapping may be common or the regions of colour used differently, for example as a mirror image. The video frames 26 can be produced in part or all of an image which can then be transmitted alongside or as a part of media content, for example in a broadcast. The sequence 28 of video frames 26 can be very complex due to the bandwidth of video available, even just a few pixels can carry the colour information needed for a particular light or group of lights and can include transitions and animations from light to light. Resolution does not need to be high so simple video formats such as those used for teletext can be adequate.

A video-to-light product (such as amBIENT XC or Light-Scene Engine) can be set up to watch the specific regions of the video sequence and map those to the relevant area of the space that is being lit by the lighting installation 4. If the video sequence is carried in the source video the area used for this may be blanked or cut off before being rendered to a screen. The video can be deliberately designed to add on a region for the lighting control video frames and this can be carried out in most standard video editing packages. Therefore this is a simple post production process. The authored sequence of video frames 26 is used to control the lights 6 of the installation 4.

Regions of the video are analysed in real-time by the video-to-light system such as those mentioned above. These generate colour palette information for each region that can then be used in a lighting script. The video authoring system for lighting makes use of this feature, and video content produced with a known region structure can therefore be used to control a set of lights set to correspond to use the same region mapping. This allows a designer to use video and image manipulation tools to create a lighting design without need for learning new skills or developing any direct programmatic control for the lights 6 that make up the lighting installation 4. The video authoring and region mapping can use a common frame of reference.

The framework used as the images in the video can be diagrammatic or literal, images of the space being modelled, or could be photographed or filmed having been carefully lit as intended using a lighting desk. The framework defines a set of regions, which can overlap, each region defining a light and/or a lighting effect. One embodiment of the framework is a grid. The framework will portray the intended lighting scene which can then be reproduced through the video-to-light system. The target space does not have to be the same as the once portrayed in the video, it can even be oriented differently or a different shape. The video can be highly animated or static. All that is needed is a basic framework for the user to work off to add colours to that framework and then place the resulting different versions of the framework in the video timeline.

The video content can also be computationally generated, in which the computation could include constraints to the region mapping information or just to create a changing image as a whole. The output video can again be distributed in a variety of ways and then mapped onto different spaces according to the region map. For example the content could be broadcast on a video channel and receivers would then feed local lighting control systems. A variation on this would allow the computation to vary the video in a way that was synchronised to another piece of content or sensor, the resulting video then being broadcast. So the video could change colour with temperature or in time to a band playing. The video can be live or recorded and even played back in synch with another media recording. The authoring process becomes one of adjusting parameters of the computation, for example changing the track of an object or cycles of colours, as illustrated in FIG. 4, where a video frame 26 has object movement added, as supported by various video editing tools.

The real world light scene can include sophisticated dynamic and interactive scripted effects, for example as shown in FIG. 4, a colour chase around the walls of the room 2. The video authored colours shown in the video frame 26 are used within the light scene but do not have to change with the scene. The video authored material can also be dynamic, so the source colours themselves would then vary in time as well as with the scripted effects, as the video frames 26 change over time in the sequence 28. The video authored material will represent the palette colours to be used by the lighting system at any point in time as before.

The video frames 26 of the sequence 28 can also be carried in a variety of synchronised yet independent meta-channels in common media formats. On a DVD or BluRay for example, the sequence 28 of video frames 26 may be carried in the Digital Teletext stream or an alternative video angle. On an audio device the sequence 28 of video frames 26 might be provided in a data channel intended for providing supporting content such as album art, lyrics or music videos. The bandwidth of these meta channels may limit the dynamics of the light controlling content, but frames can be sampled to lower the bandwidth used, without detracting from the colours contained within frames 26. The video sequence 28 can be distributed in many different ways, for example as part of a broadcast, webcast or streaming signal.

The approach can also be used as of itself, purely to create an ambient experience without any correlations with other media. Requiring only a low resolution rendering it can run on very basic hardware and is not reliant on high quality digital formats. For example, the technique can be used for authoring to a movie timeline using colour picking from the image or palette into a grid. A VJ (video jockey) style interface to trigger lighting clip-art in real time could also harness the methodology described above. A music visualiser output could also be manipulated into a structure that could then be used to create the video frames 26 required to control the lighting installation 4.

FIG. 6 is a flowchart that sums up the methodology of controlling a plurality of lights of a lighting installation. The method comprises the steps of, firstly, step S6.1, which comprises receiving a framework defining the plurality of lights of the lighting installation, the framework comprising a video frame, secondly, step S6.2, which comprises creating a plurality of different coloured versions of the framework, thirdly, step S6.3, which comprises locating each of the different coloured versions of the framework on a timeline of video frames, fourthly, step S6.4, which comprises applying transition effects between the located different coloured versions of the framework on the timeline to create intermediate video frames thereby generating a sequence of video frames, fifthly, step S6.5, which comprises transmitting the sequence of video frames to a lighting controller for the lighting installation, and finally, step S6.6, which comprises controlling the plurality of lights of the lighting installation according to the sequence of video frames.

The method provides a new kind of light experience authoring and playback delivery. Standard video editing and authoring tools can be used by a designer to allow the creation of an animated sequence of colours to be used in the control of lights in a lighting installation. This sequence can be associated with a pre-existing piece of video material or other media. Creating lighting experiences in this way does not require specialist design and programming skills to set up lighting sequences on professional lighting controllers which is a major drawback of existing approaches to the problem of controlling lights in complex lighting installations. Anyone familiar with image and video editing software can create complex lighting control instructions using this approach.

There are two main advantages to the new approach. Firstly, there is no need for a new representation language for the lighting information. The colour information is provided in a format that is apparent and intuitive to most people and can be extrapolated by the video to light algorithms of the lighting system. Secondly, the authoring of such information can be done in a domain where there are already well established tools and techniques and plenty of people are sufficiently skilled to easily interpret the representation in terms that are familiar to them. Creation of lighting experiences around media can therefore be part of a standard post production process without learning new production skills or developing/purchasing new software.

1. A method of controlling a plurality of lights of a lighting installation, the method comprising:
receiving a framework defining the plurality of lights of the lighting installation, the framework comprising a video frame,
creating a plurality of different colored versions of the framework,
locating each of the different colored versions of the framework on a timeline of video frames,
applying transition effects between the located different colored versions of the framework on the timeline to create intermediate video frames thereby generating a sequence of video frames,
transmitting the sequence of video frames to a lighting controller for the lighting installation, and
controlling the plurality of lights of the lighting installation according to the sequence of video frames.

2. A method according to claim 1, wherein the framework comprises a two-dimensional grid.

3. A method according to claim 1 wherein the framework defines the relative location of the plurality of lights of the lighting installation.

4. A method according to claim 3, wherein the framework defines the three-dimensional location of the plurality of lights of the lighting installation.

5. A method according to claim 1 further comprising receiving an input defining the nature of a transition effect to be applied between two different colored versions of the framework located on the timeline.

6. A system for controlling a plurality of lights of a lighting installation, the system comprising a processor arranged to:
receive a framework defining the plurality of lights of the lighting installation, the framework comprising a video frame,
create a plurality of different colored versions of the framework,
locate each of the different colored versions of the framework on a timeline of video frames,
apply transition effects between the located different colored versions of the framework on the timeline to create intermediate video frames thereby generating a sequence of video frames,
transmit the sequence of video frames to a lighting controller for the lighting installation, and
control the plurality of lights of the lighting installation according to the sequence of video frames.

7. A system according to claim 6, wherein the framework comprises a two-dimensional grid.

8. A system according to claim 6, wherein the framework defines the relative location of the plurality of lights of the lighting installation.

9. A system according to claim 8, wherein the framework defines the three-dimensional location of the plurality of lights of the lighting installation.

10. A system according to claim 6, wherein the processor is further arranged to receive an input defining the nature of a transition effect to be applied between two different colored versions of the framework located on the timeline.

11. A computer program product on a non-transitory computer readable medium for controlling a plurality of lights of a lighting installation, the product comprising instructions for:
receiving a framework defining the plurality of lights of the lighting installation, the framework comprising a video frame,
creating a plurality of different colored versions of the framework,
locating each of the different colored versions of the framework on a timeline of video frames,
applying transition effects between the located different colored versions of the framework on the timeline to create intermediate video frames thereby generating a sequence of video frames,
transmitting the sequence of video frames to a lighting controller for the lighting installation, and
controlling the plurality of lights of the lighting installation according to the sequence of video frames.

12. The computer program product according to claim 11, wherein the framework comprises a two-dimensional grid.

13. The computer program product according to claim 11 wherein the framework defines the relative location of the plurality of lights of the lighting installation.

14. The computer program product according to claim 13, wherein the framework defines the three-dimensional location of the plurality of lights of the lighting installation.

15. The computer program product according to claim 11 further comprising receiving an input defining the nature of a transition effect to be applied between two different colored versions of the framework located on the timeline.
